(19) United States
(12) Patent Application Publication
(10) Pub. No.: US 2009/0134078 A1
(43) Pub. Date: May 28, 2009

(54) Oil filter assembly

(76) Inventors: Friedhelm Pfitzer, Rangendingen (DE); Peter Jungmann, Bisingen (DE); Alexander Maute, Hechingen-Stetten (DE)

Correspondence Address: DREISS, FUHLENDORF, STEIMLE & BECKER, POSTFACH 10 37 62, D-70032 STUTTGART, DE

(21) Appl. No.: 11/990,705

(22) PCT Filed: Aug. 18, 2006
(86) PCT No.: PCT/EP2006/008135

§ 371 Date: Feb. 20, 2008

(30) Foreign Application Priority Data
Aug. 25, 2005 (DE) 10 2005 041 037.5

(51) Int. Cl. B01D 35/147

(52) U.S. Cl. 210/133

(57) ABSTRACT

An oil filter arrangement (10) comprises a housing (12) provided with a reception compartment for receiving a filter element (20), which is insertable in the housing and which the oil radially passes through, an oil output and a support tube (22) which is arranged in the reception compartment and supports the filter element (20), wherein a bypass valve (24) which is arranged in the support tube (22) opens when a limiting pressure is exceeded and which the oil flowing from the oil input to the oil output passes through by passing the filter element, said bypass valve comprising a valve seat (36), a valve body (38) interacting therewith and a cage-like lid part (49). The support tube (22) and the lid part (40) are embodied in a single piece form of a plastic material.

This application is the national stage of PCT/EP2006/008135 filed on Aug. 18, 2006 and claims Paris Convention priority to DE 10 2005 041 037.5 filed Aug. 25, 2005.

### BACKGROUND OF THE INVENTION

The invention concerns an oil filter arrangement comprising a housing with a receiving space for a filter element that can be inserted into the housing and through which oil can flow in a radial direction, an oil inlet, an oil outlet, and a support tube provided in the receiving space and bearing the filter element, wherein a bypass valve is provided in the support tube, which opens when a limit pressure has been exceeded and through which oil can flow from the oil inlet to the oil outlet thereby bypassing the filter element, wherein the bypass valve comprises a valve seat, a valve body that cooperates with the valve seat, and a lid part that is designed like a cage.

DE 102 59 884 A1 discloses an oil filter arrangement of this type. The bypass valve is thereby seated at the free end of the support tube.

DE 195 02 020 C2 discloses a similar oil filter arrangement. The bypass valve of this oil filter arrangement is also seated at the free end of the support tube. The bypass valve thereby consists of a valve body, a valve spring and a two-part valve housing that comprises a valve seat and a lid part.

The arrangement of the bypass valve on the support tube is comparatively difficult in conventional oil filter arrangements. The bypass valve thereby consists of several parts, which must be joined to each other and also be mounted to the support tube.

It is the underlying purpose of the present invention to provide an oil filter arrangement having a simplified structure that still provides reliable function.

### SUMMARY OF THE INVENTION

This object is achieved by an oil filter arrangement of the above-mentioned type in that the support tube and the lid part are produced in one piece from plastic material. This considerably reduces the number of components to be joined. The need to fix the lid part to the valve seat and/or to the support tube is thus completely avoided. The bypass valve therefore automatically assumes a predefined position in the support tube. Moreover, only one component must be mounted to the support tube, i.e. the valve seat. The conventional complicated connection of the lid part to the valve seat is avoided by the invention. The support tube including lid part may thereby be produced as an injection-molded part, wherein e.g. the support tube is initially injection-molded and in a further injection-molding process, the lid part can be injected onto the support tube. The support tube including lid part then forms an inseparable one-piece unit. The lid part is consequently integrated in the support tube.

The lid part is disposed in the area of the free end of the support tube. This is advantageous in that the valve seat including valve body can be inserted into the support tube in a comparatively simple fashion. The lid part is advantageously disposed on the side of the support tube facing the lid that closes the receiving space.

In an advantageous embodiment of the invention, a radially inwardly directed narrowing is provided in the area of the free end of the support tube, on which the lid part is disposed. The radially inwardly directed narrowing ensures that there is sufficient space between the cage-like lid part and the support tube through which oil can flow, in particular, when the overflow valve is open. The lid part can extend from the narrowing e.g. in an axial and/or a radial direction.

Moreover, the inner diameter of the narrowing is equal to or slightly larger than the outer diameter of a center section of the valve seat. The valve seat is thereby centered in the narrowing and is advantageously substantially fixed in the radial direction.

The lid part may have a guiding section in order to guide the valve body in a predefined and accurately positioned fashion. The guiding section may thereby be designed e.g. as a circular-cylindrical guiding pin.

A spring element may be provided for holding the bypass valve in the closed position and is supported on the lid part to load the valve body against the valve seat. The spring element may thereby be e.g. a helical spring.

In a further advantageous fashion, the valve seat of the inventive oil filter arrangement is undetachably connected to the support tube. This effectively prevents release of the valve seat from the support tube.

In order to dispose the valve seat at the exact position on the support tube, in accordance with the invention, the valve seat may moreover have an annular design and comprise a radially outwardly projecting collar for connecting to an abutment section of the support tube. The radially outwardly extending collar is additionally advantageous in that sufficient material is provided to realize a suitable connection.

In order to provide an undetachable connection, the collar may be welded to the abutment section, in particular, through ultrasound welding.

The collar of the valve seat advantageously forms the free end of the support tube, since in this case, the valve seat can be fastened in a favorable fashion.

It is advantageous when at least sections of the narrowing on the side facing the free end of the support tube have an annular front face that forms the abutment section for the collar of the valve seat. By providing such a front face, sufficient material is provided in order to reliably connect the valve seat to the support tube.

The front face may thereby be bordered by an edge projecting in an axial direction, thereby obtaining additional centering of the valve seat on the support tube.

In accordance with the invention, it is also advantageous for the outer diameter of the edge to be equal to or smaller than the outer diameter of the support tube. This is advantageous in that the edge is not in the way when the filter element is disposed onto the support tube and does not impair disposal of the filter element onto the support tube.

It is thereby feasible that the valve seat is undetachably connected to the support tube e.g. by welding in the area of the center section that abuts the narrowing.

In accordance with a further embodiment of the invention, the support tube including bypass valve is inserted into the receiving space and undetachably fixed there. This considerably simplifies the production of the oil filter arrangement. The structural group to be handled separately, support tube including bypass valve, can be previously mounted and be undetachably fixed in the receiving space, in particular, to the housing.

Further details and advantageous embodiments of the invention can be extracted from the following description which describes and explains in more detail the invention with reference to the embodiment shown in the drawing.

### BRIEF DESCRIPTION OF THE DRAWING

FIG. 1 shows a longitudinal section through an inventive oil filter arrangement; and

FIG. 2 shows an enlarged view of the area designated by II in FIG. 1.

### DESCRIPTION OF THE PREFERRED EMBODIMENT

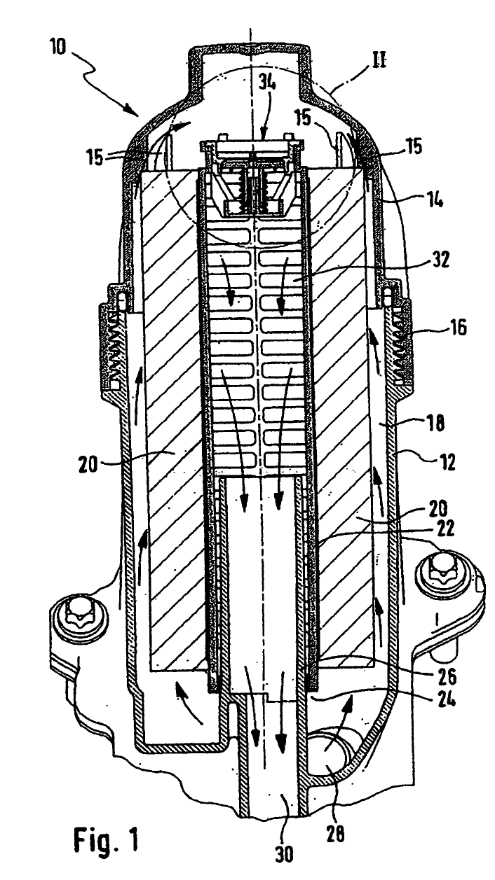

FIG. 1 shows an inventive oil filter arrangement 10. The oil filter arrangement 10 comprises a housing 12 that can be closed by a lid 14. The lid 14 can be screwed onto the housing 12 via a thread 16. The housing 12 forms a receiving space 18 for a filter element 20. The filter element 20 is thereby disposed onto a support tube 22. The support tube 22 itself is undetachably mounted to the housing in the foot area 24 of a pressure tube 26 on the housing side.

The oil filter arrangement 10 moreover has an oil filter inlet 28 for crude oil to be filtered and an oil outlet 30 for filtered purified oil.

In the normal operating state of the oil filter arrangement, soiled crude oil flows through the oil inlet 28 into the receiving space 18. Due to the pressure difference between the oil inlet side and the oil outlet side, the oil flows in a radial direction through the filter element 20. The filtered purified oil then flows in a radial direction through the support tube 22 which has a large number of openings 32 for passage of the purified oil. The purified oil, filtered in this fashion, then leaves the oil filter arrangement 10 via the oil outlet 30. If the pressure difference between the oil inlet side and the oil outlet side exceeds a certain limit pressure e.g. due to the filter element that clogs due to soiling, a bypass valve 34 opens, which is provided at the free end of the support tube 22. When the bypass valve 34 is open, non-filtered oil consequently flows from the oil inlet 28 through the bypass valve 34 to the oil outlet 30.

Support ribs 15 are provided on the inner side of the lid 14 for loading the filter element in an axial direction towards the bottom of the receiving space 18. The oil can flow through the ribs 15 into the upper area of the lid 14.

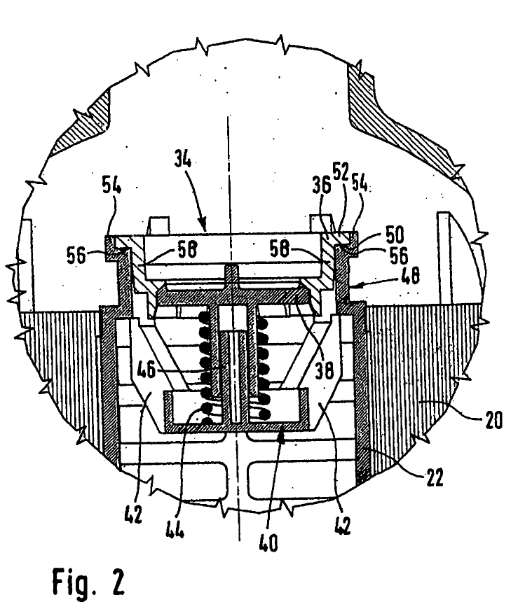

As is clearly shown in the enlarged illustration of FIG. 2, the bypass valve 34 comprises a valve seat 36, a valve body 38 that cooperates with the valve seat, and a cage-like lid part 40 that is designed in one piece with the support tube 22. The lid part is thereby molded to the support tube 22 via a total of four webs 42, two of which are shown in the sectional view of FIG. 2. The support tube 22 including lid part 40 is thereby produced from plastic material. A spring element 44 is supported on the lid part 40, which sealingly loads the valve body 38 against the valve seat 36. When the limit pressure has been reached, the valve body 38 moves in an axial direction opposite to the spring force of the spring element 44.

As can be gathered from FIG. 2, the lid part 40 has a guiding pin 46 in its axially central area, which guides the valve body in an axial direction.

The narrowing 48 has an annular front face 50 on the side facing the free end of the support tube, which is used as an abutment section for a collar 52 of the valve seat 36 that is directed in a radial outward direction. The front face 50 is axially and radially bordered by an edge 54 on the support tube side. The collar 52 is undetachably connected to the support tube 22 through a weld connection 56, in particular through an ultrasound weld connection, in the area of the front face 50.

As is also clearly shown in FIG. 2, the inner diameter of the narrowing 48 is the same or slightly larger than the outer diameter of a center section 58 of the valve seat 36 that abuts the narrowing 48, thereby ensuring exact positioning of the valve seat in the support tube 22. In accordance with the invention, a weld connection may be provided between the support tube 22 and the valve seat 36 in the area of the center section 58 either in addition to or instead of the weld connection 56. In accordance with the invention, any other type of undetachable connection is feasible instead of welding, e.g. a glue connection with positive material fit.

In order to ensure that the filter element 20 can be easily pushed onto the support tube 22, the outer diameter of the edge 54 is smaller than the outer diameter of the remaining support tube 22 apart from the narrowing 48.

We claim:

1-15. (canceled)

16. An oil filter arrangement accommodating a filter element, the oil filter arrangement comprising:
a housing defining a receiving space for the filter element when the filter element is inserted into said housing, said housing structured to direct oil flow in a radial direction through the filter element, said housing having an oil inlet and an oil outlet;
a plastic support tube disposed in said receiving space to bear the filter element, said support tube having an integral plastic cage-like lid part, wherein a radially inwardly directed narrowing is provided in an area of a free end of said support tube on which said lid part is disposed; and
a bypass valve disposed in said support tube, said bypass valve opening when a limit pressure is exceeded and through which oil can flow from said oil inlet to said oil outlet, thereby bypassing the filter element, wherein said bypass valve has a valve seat and a valve body that cooperates with said valve seat and with said cage-like lid part, wherein an inner diameter of said narrowing is equal to or slightly larger than an outer diameter of a center section of said valve seat such that said valve seat is centered in said narrowing when said valve seat and valve body are introduced into said support tube.

17. The oil filter arrangement of claim 16, wherein said lid part has a guiding section for guiding said valve body.

18. The oil filter arrangement of claim 16, further comprising a spring element which is supported on said lid part to urge said valve body against said valve seat.

19. The oil filter arrangement of claim 16, wherein said valve seat is undetachably connected to said support tube.

20. The oil filter arrangement of claim 16, wherein said valve seat has an annular design and a radially outwardly projecting collar for connection to an abutment section of said support tube.

21. The oil filter arrangement of claim 20, wherein said collar is welded to said abutment section or is welded to said abutment section through ultrasound welding.

22. The oil filter arrangement of claim 20, wherein said collar forms a free end of said support tube.

23. The oil filter arrangement of claim 20, wherein at least sections of said narrowing on a side facing said free end of said support tube have an annular front face that forms said abutment section for said collar of said valve seat.

24. The oil filter arrangement of claim 23, wherein said front face is bordered by an edge that projects in an axial direction.

25. The oil filter arrangement of claim 24, wherein said edge and said collar form said free end of said support tube.

26. The oil filter arrangement of claim 24, wherein an outer diameter of said edge is equal to or smaller than an outer diameter of said support tube.

27. The oil filter arrangement of claim 16, wherein said support tube and said bypass valve are inserted and undetachably fixed in said receiving space.
